(19) United States
(12) Patent Application Publication
(10) Pub. No.: US 2018/0191562 A1
(43) Pub. Date: Jul. 5, 2018

(54) PARAMETER SETTING METHOD FOR SYSTEM BUS AND DEVICE THEREOF

(71) Applicant: UBTECH Robotics Corp., Shenzhen (CN)

(72) Inventors: Youjun Xiong, Shenzhen (CN); Hailang Zhou, Shenzhen (CN); Musen Zhang, Shenzhen (CN)

(21) Appl. No.: 15/694,867

(22) Filed: Sep. 4, 2017

(30) Foreign Application Priority Data
Dec. 30, 2016 (CN) 201611253810.3

(51) Int. Cl. H04L 12/24; H04L 12/40; H04L 1/16; H04L 1/18

(52) U.S. Cl. CPC H04L 41/0803; H04L 12/40; H04L 1/1642; H04L 2212/00; H04L 41/0869; H04L 2012/40215; H04L 1/1809

(57) ABSTRACT

The present disclosure relates to a parameter setting method for system bus of a robot. The method includes sending parameters to the node; sending a parameter setting request to the node; and receiving the parameter setting response from the node. The present disclosure further provides a parameter setting device for system bus of a robot.

### CROSS REFERENCE TO RELATED APPLICATIONS

This application claims priority to Chinese Patent Application No. 201611253810.3, filed Dec. 30, 2016. which is hereby incorporated by reference herein in its entirety.

### BACKGROUND

### 1. Technical Field

The present disclosure; relates to data setting field, and particularly to a parameter setting method for hoses and a controller for robots.

### 2. Description of Related Art

Controller Area Network (CAN) bus is a serial communication protocol for real-time applications. It adopts twisted pair to transmit signals, which is one of the most widely used field buses in the world.

Nowadays, robots are characterized by the attributes below; 1. Motors of each of the execution nodes are directed to heavy loading, large currents, and frequently on and off, strong electric magnetic interfere source; 2. A lot of execution nodes; 3. A lot of nodes have to be controlled by a high speed and synchronous manner when performing various action; 4. The demand toward high reliability clue to human interactions; 5. Facing more complex electric-magnetic environment when operating in a more dangerous environment in the future.

Based on above, bad environments and mission complexity lead to higher reliability toward data processing and communication system, and thus the CAN bus protocol has to be enhanced.

### BRIEF DESCRIPTION OF THE DRAWINGS

FIG. 1 is a flowchart illustrating a parameter setting method for system bus in accordance with one embodiment of the present disclosure.

FIG. 2 is a flowchart illustrating a parameter setting method for system bus in accordance with another embodiment of the present disclosure.

FIG. 3 is a flowchart illustrating a parameter setting method for system bus in accordance with another embodiment of the present disclosure.

FIG. 4 is a flowchart illustrating a parameter setting method for system bus in accordance with another embodiment of the present disclosure.

FIG. 5 is a schematic view of a parameter setting device for system bus of a robot in accordance with one embodiment of the present disclosure.

FIG. 6 is a schematic view of a parameter setting device for system bus of a robot in accordance with another embodiment of the present disclosure.

FIG. 7 is a flowchart illustrating a parameter setting method for system bus in accordance with another embodiment of the present disclosure.

### DETAILED DESCRIPTION

To clarify the purpose, technical solutions, and the advantages of the disclosure, embodiments of the invention will now be described more fully hereinafter with reference to the accompanying drawings, in which embodiments of the invention are shown. The figure and the embodiment described according to figure are only for illustration, and the present disclosure is not limited to these embodiments. It should be noted that the relational terms herein, such as “first” and “second”, are used only for differentiating one entity or operation, from another entity or operation, which, however do not necessarily require or imply that there should be any real, relationship or sequence. Moreover, the terms “comprise”, “include” or any other variations thereof are meant to cover non-exclusive including, so that the process, method, article or device comprising a series of elements do not only comprise those elements, but also comprise other elements that are not explicitly listed or also comprise the inherent elements of the process, method, article or device. In the case that there are no more restrictions, an element qualified by the statement “comprises a . . . ” does not exclude the presence of additional identical elements in the process, method, article or device that comprises the said element.

The disclosure provides a CAN2.0B bus protocol solution, for communication between a Table of a robot and a plurality of execution nodes, i.e., servos. The solution relates to modify standard data frame and extended data frame described in the CAN2.0B, such that identifiers of arbitration field and fields of segments of data field in the standard data frame and the extended data frame are configured with new functions. The identifier field of the arbitration field in the standard data frame and the extended data frame is modified respectively as Table A-1 and Table A-2.

TABLE A-1
Modification regarding identifier fields of
arbitration field of standard data frame

| | | | | | |
|---|---|---|---|---|---|
| Definitions in identifier | ID10 | ID9 | ID8 | . . . | ID0 |
| fields of arbitration field | | | | | |
| New definition | M1 | M0 | CH8 | . . . | CH0 |

Wherein M1 and M0 indicates fame mode, and the values of M1 and M0 may include 00, 01, 10, and 11;

CH8-CH0 indicate the communication channels of the nodes, which ranges from 0 to 511. When Channel=0, the data frame is a broadcast frame. All nodes may receive the broadcast frame.

TABLE A-2
Modification regarding identifier fields of arbitration field of expanded data frame

| | | | | | | | | | | | | | |
|---|---|---|---|---|---|---|---|---|---|---|---|---|---|
| Original | ID | ID | ID 8 | ID | ID 6 | ID | . . . | ID0 | EID | EID | EID | . . . | EID0 |
| definition | 10 | 9 | | 7 | | 5 | | | 17 | 16 | 15 | | |
| New | M1 | M0 | EM0 | N | END | I7 | . . . | I2 | I1 | I0 | CH15 | . . . | CH0 |
| definition | | | | | | | | | | | | | |

Wherein M1 and M0 indicate the frame mode, and the values of M1 and M0 may include 00, 01, 10, and 11;

Wherein EM0 indicates the extended frame mode. The values of the EM0 include 0 and 1. The definition of the frame modes of the extended frame is shown as Table A-11.

TABLE A-11
Definition of frame mode of expanded data frames

| M1 | M0 | EM0 | Description | Function |
|---|---|---|---|---|
| 0 | 0 | 0 | Node control | Control node to execute action |
| | | | instruction frame | |
| 0 | 1 | 0 | Node return | Return collecting data of sensoring |
| | | | instruction frame | node or status of node |
| 0 | 0 | 1 | Uploading node | Use extended data frame to transmit |
| | | | serial code frame | |
| 0 | 1 | 1 | Configuring | Configure data channels for nodes |
| | | | channel frame | |
| 1 | 0 | 0 | Block control | Sending terminals confirm whether |
| | | | instruction frame | data have been correctly received by |
| 1 | 1 | 0 | Block return | the receiving terminal. |
| | | | instruction frame | |
| 1 | 0 | 1 | Output frame of | Determining a lost frame according |
| | | | block data | to sequence number of data frame, |
| 1 | 1 | 1 | Input frame of | and instructions frame of block |
| | | | block data | control and block return are adopted |
| | | | | to confirm re-transmission |

N is a reserved bit, which has not been configured temporarily.

END indicates whether the frame is the last frame during the data transmission. When END is equal to “0”, the frame is not the last frame. When END is equal to “1”, the frame is the last frame.

I7-I0 is an 8 bit self-increasing cycle code, indicating the sequence number of the data, which ranges from 0 to 255.

CH15-CH0 indicates communication channel of node. The value ranges from 0 to 65535. When the value of the “Channel” is equal to 0, the data frame is the broadcast frame. All nodes may receive the broadcast frame.

Data field In the standard data fame and in the extended data frame is modified as Table B-1.

TABLE B-1
modification of definitions of data field of CAN 2.0B protocol data frame

| Original data field definition | | D0 | D1 | D2 | D3 | D4 | D5 | D6 | D7 |
|---|---|---|---|---|---|---|---|---|---|
| New data field | Node control | CMD | D0 | D1 | D2 | D3 | D4 | D5 | D6 |
| definition | instruction frame | | | | | | | | |
| | Node return instruction | CMD | D0 | D1 | D2 | D3 | D4 | D5 | D6 |
| | frame | | | | | | | | |
| | Uploading node serial | D0 | D1 | D2 | D3 | D4 | D5 | D6 | D7 |
| | code frame | | | | | | | | |
| | Configuring frame of | D0 | D1 | D2 | D3 | D4 | D5 | D6 | D7 |
| | channels | | | | | | | | |
| | Block control | CMD | D0 | D1 | D2 | D3 | D4 | D5 | D6 |
| | instruction frame | | | | | | | | |
| | Block return instruction | CMD | D0 | D1 | D2 | D3 | D4 | D5 | D6 |
| | frame | | | | | | | | |
| | Output frame of block | D0 | D1 | D2 | D3 | D4 | D5 | D6 | D7 |
| | data | | | | | | | | |
| | Input frame of block | D0 | D1 | D2 | D3 | D4 | D5 | D6 | D7 |
| | data | | | | | | | | |

Wherein CMD relates to secondary instruction. Nodes may conduct their own instruction set, see Table B-2.

D0˜D6 relate to data earned by secondary instruction.

D0˜D7 relate to data carried by each frame during data transmission. The 8 bits are configured to enhance the transmission efficiency.

TABLE B-2
A portion of CMD instructions

| CMD | Instruction message | Descriptions |
|---|---|---|
| F6 | Date block abnormal | Main controller notifies node |
| | reception for main | that data blocks may be lost. |
| | controller | |
| F5 | Data block abnormal | Node notifies main controller |
| | reception for node | that data blocks may be lost |
| F4 | Instructions requesting | Main controller requests node to |
| | node to receive parameters | receive corresponding parameters |
| | | within data block |
| F3 | Replying to request of | Confirming with main controller |
| | parameter reception | that node is ready to receive |
| | | corresponding parameters. |
| F2 | Instructions requesting | Main controller requests node to |
| | node to configure | configure corresponding parameters, |
| | parameters | stored in the buffer, to a parameter |
| | | Table |
| F1 | Replying status of | Node reports status of parameter |
| | parameter configuration | configuration to main controller |

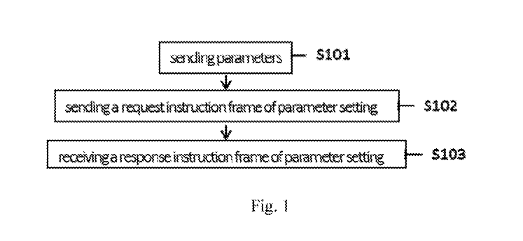

FIG. 1 is a flowchart illustrating a parameter setting method for system bus in accordance with one embodiment of the present disclosure.

As shown in FIG. 1, the method includes step S101: sending parameters; step S102: sending a request instruction frame of parameter setting; step S103: receiving a response instruction frame of parameter setting.

In one embodiment, in step S101, a main controller sends the parameters to a node, wherein the parameters are encapsulated into M number of data frames, and the M number of data frames are sent to the node, wherein M is a positive integer equal to or greater than 1, and M is equal to or less than 128. Wherein the step of sending the N-th data frame further includes reporting an abnormal data transmission and resending the data frames, wherein N is the positive integer equal to or less than M.

The step of reporting the abnormally transmitted data frame and the resending the data frames further includes: sequentially sending a first data frame to the (N−1)-th data frame to the node for one time and sending the N-th data frame to the node for one or more than one time when N number of the data frames is transmitted, wherein N is equal to a preset number between one and M, or N is equal to or greater than M/2, or when the last data frame is transmitted, i.e., when N=M; receiving a message reporting an abnormal data transmission from the node, wherein the message of the abnormal data transmission includes the number of the abnormally transmitted data frames and the sequence number of the abnormally transmitted data frames; rereading the data frames being transmitted abnormally to the node upon receiving the message. Wherein the abnormally transmitted, data frames are a portion or all of the data frames from the first data frame to the (N−1)-th data frame.

Block abnormal instructions indicating main controller abnormal block transmission of the main controller are shown as Table 1.

TABLE 1

| | | The value | |
|---|---|---|---|
| Bit | Description | range | Function |
| 0 | CMD instruction | 0XF6 | Main controller notifies node |
| | | | of data lost |
| 1 | The number of the | 0-6 | Absolute value indicates the |
| | abnormally transmitted | | number of block data that |
| | data frames | | have not been received |
| 2-7 | The sequence number of | 0-255 | The index set of block data |
| | the abnormally trans- | | that have not been received |
| | mitted data frames | | |

Block abnormal instructions indicating abnormal block transmission of node are shown as Table 2.

| | | The value | |
|---|---|---|---|
| Bit | Description | range | Function |
| 0 | CMD instruction | 0XF5 | Node notifies main controller |
| | | | of data lost |
| 1 | The number of | 0-6 | Absolute value indicates the |
| | abnormally trans- | | number of block data that |
| | mitted data frames | | have not been received |
| 2-7 | The sequence number of | 0-255 | Index set of block data that |
| | the abnormally trans- | | have not been received |
| | mitted data frames | | |

The usage of for block abnormal instruction, such as 0XF6 (for main controller) and 0XF5 (for the nodes) are the same. The difference resides in the transmitting directions between main controller and nodes.

The process of the parameter block transmission will be described hereinafter. The sending terminal sequentially sends the first to the (N−1)-th data frames to the receiving terminal, wherein the sending terminal is the main controller and the receiving terminal is the node. The sending terminal resends the N-th data frame to the receiving terminal repeatedly when the N number of the data frames have been sent, wherein N is a preset number between one and M, or N is equal to or greater than M/2. Besides, when the last date frame is transmitted, i.e., the M-th data frame (N=M), the M-th date frame is also resent to the receiving terminal repeatedly. The receiving terminal sends a message reporting an abnormal data transmission to the sending terminal upon receiving a duplicate data frame. The sending terminal receives the message of the abnormal data transmission from the receiving terminal. As shown in Table 1 and Table 2, the message of the abnormal data transmission includes the number of the abnormally transmitted data frames and the sequence number of the abnormally transmitted data frames during the data transmission. The sending terminal resends the corresponding data frames to the receiving terminal according to the sequence number of the abnormally transmitted data frames upon receiving the message, that is, when the number of the abnormally transmitted data frame is not equal to 0. In order to check whether there is an abnormal data transmission or not, the sending terminal resends the N-th data frame to the receiving terminal. The receiving terminal sends the message of the abnormal data transmission to the sending terminal upon receiving the duplicate N-th data frame. The sending terminal stops resending the N-th data frame to the receiving terminal upon determining no abnormal data frame has been transmitted, that is, when the number of the abnormal data frames is equal to 0. The sending terminal continues sending the (N+1)-th data frame through the (M−1)-th data frame to the receiving terminal when N number of the data frames have been sent, wherein N is greater than or equal to M/2. When N=M, the data transmission is completed.

In step S102, sending a request instruction frame of parameter setting to the node, wherein the request instruction frame of parameter setting requests the node to conduct a configuration, according to the parameters.

Request instructions of parameter setting are shown as Table 3.

TABLE 3

| | | The value | |
|---|---|---|---|
| Bit | Description | range | Function |
| 0 | CMD instruction | 0XF2 | Main controller requests node |
| | | | to store received parameters |
| 1 | Length of | 128 | Parameter utilizing string |
| | parameter data | | transmission |

In step S103, the main controller receives the response instruction frame of parameter setting from the node, wherein the response instruction frame of parameter setting reports a parameter configuration result to the main controller.

Response instructions of parameter setting are shown as Table 4.

TABLE 4

| | | The value | |
|---|---|---|---|
| Bit | Description | range | Function |
| 0 | CMD | 0XF1 | Node replies main controller |
| | instruction | | whether received parameters |
| | | | are stored |
| 1 | Reply setting | 0-3 | 0: error in name of parameter; |
| | result | | 1: error in format of parameter |
| | | | 2: failure in parameter setting |
| | | | 3: success in parameter setting |

In the embodiment, the parameter setting method for system bus can realize the transmission accuracy and the setting of the parameters for each node of the robot.

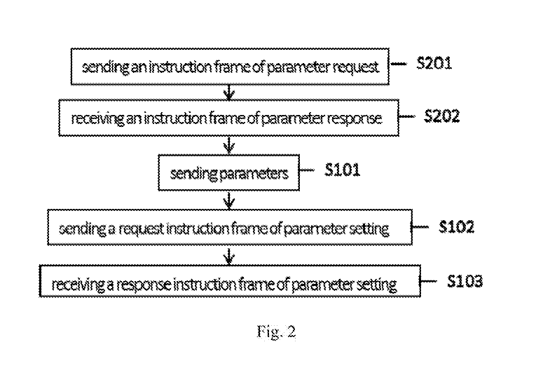

FIG. 2 is a flowchart illustrating a parameter setting method for system bus in accordance with another embodiment of the present disclosure.

For sake of convenience of description, the same configuration between the previous embodiment and this embodiment is no longer detailed described, but focuses only on the difference between the previous embodiment and the embodiment. In FIG. 2, the step which is the same as or similar to the previous embodiment use the same reference numerals.

As shown In FIG. 2, the method further includes step S201: sending an instruction frame of parameter request; and step S202: receiving an instruction frame of parameter response.

Alternatively, in step S201, the main controller sends the instruction frame of parameter request to the node. The instruction frame of parameter request may include the node information, the parameter information, the frame-mode indication information, and the frame-type indication information. The instruction frame of parameter request is sent by the main controller to request the node to receive the parameters to be set.

Instructions of parameter request are shown as Table 5.

TABLE 5

| | | The value | |
|---|---|---|---|
| Bit | Description | range | Function |
| 0 | CMD instruction | 0XF4 | Main controller request node to |
| | | | receive parameters to be set |
| 1 | Length of | 128 | Parameter utilizing string |
| | parameter data | | transmission |

In step S202, the main controller receives the instruction frame of parameter response from the node. The instruction frame of parameter response may include the node information, the parameter information, the frame-mode indication information, and the frame-type indication information. The instruction frame of parameter response is sent by the node to reply the main controller to receive the parameter setting data.

The instructions of parameter response are shown in Table 6.

TABLE 6

| | | The value | |
|---|---|---|---|
| Bit | Description | range | Function |
| 0 | CMD instruction | 0XF4 | Node notifies main controller |
| | | | whether receiving parameters |
| | | | to be set is ready. |
| 1 | Length of | 128 | Parameter utilizing string |
| | parameter data | | transmission |

In one scenario, main controller of a robot may upgrade the data on the node 10. The receiving buffer is 128 bits. The CMD instructions relating to the operations are shown as Table B-2.

Main controller sends the parameter received request to the node 10. The corresponding fields m the message are set as; MIM0EM0=100, channel=10, CMD=0XF4, and D1-D4=128.

The node 10 sends the parameter response request to the main controller. The corresponding fields in the message are set as: MIM0EM0=110, channel=10, CMD=0XF4, and D1-D4=128.

After the main controller receives the response, the main controller starts to send the parameters to the node by utilizing a block data transmission method.

The main controller sends the parameter setting request to the node 10. The corresponding fields in the message are set as: MIM0EM0=100, channel=10, CMD=0XF2, and D1-D4=128.

The node receives the request and validates the parameters to determine whether to store the parameters or not.

The node sends the parameter setting response to the main controller. The corresponding fields in the message are set as: MIM0EM0=110, channel=10, CMD=0XF1, and D1=parameter setting completed condition.

The parameter setting process is completed.

In the embodiment, the parameter setting method for system bus can realize the transmission accuracy and the setting of the parameters for each node of the robot.

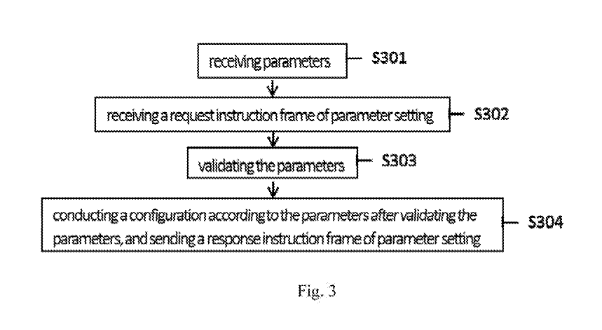

FIG. 3 is a flowchart illustrating a parameter setting method for system bus in accordance with another embodiment of the present disclosure.

For sake of convenience of description, the same configuration between the previous embodiment and this embodiment is no longer detailed described, but focuses only on the difference between the previous embodiment and the embodiment.

As shown in FIG. 3, the method includes step S301: receiving parameters; step S302: receiving a request instruction frame of parameter setting; step S303: validating the parameters; and step S304: conducting a configuration according to the parameters after validating the parameters, and sending a response instruction frame of parameter setting.

In one embodiment, in step S301, the node receives the parameters from the main controller. In step S302, the node receives the request instruction frame of parameter setting from the main controller. In step S303, the node/validates the received parameters to determine whether to store the parameters or not. In step S304, conducting a configuration according to the parameters after validating, and sending the response instruction frame of parameter setting to the main controller to report the parameter configuration result. Wherein the parameters are encapsulated into M number of data frames, and the M number of data frames are sequentially received by the node, M is the positive integer equal to or greater than 1, and M is equal to or less than 128. The node further reports the abnormal data transmission and resends the data frames when receiving the N-th data frame. The process of reporting the abnormal data transmission and the resending process is the same as the previous embodiment, and thus will be omitted hereinafter. Wherein N is the positive integer equal to or less than M, and N is equal to or greater than M/2, or N is equal to M.

In the embodiment, the parameter setting method for system bus can realize the transmission accuracy and the setting of the parameters for each node of the robot.

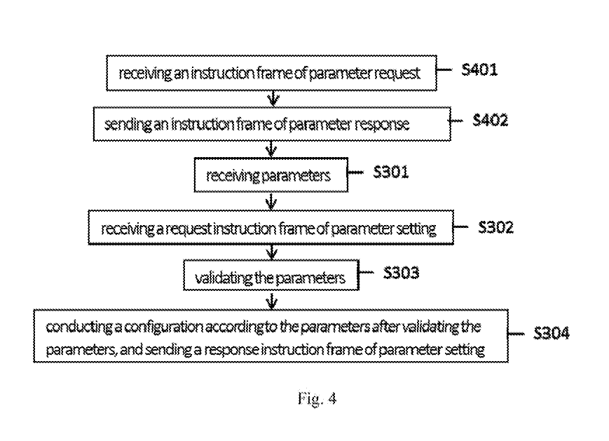

FIG. 4 is a flowchart illustrating a parameter setting method for system bus in accordance with another embodiment of the present disclosure.

For sake of convenience of description, the same configuration between the previous embodiment and this embodiment is no longer detailed described, but focuses only on the difference between the previous embodiment and the embodiment. In FIG. 4, the step which is the same as or similar to the previous embodiment use the same reference numerals.

As shown in FIG. 4, the method further includes step S401: receiving an instruction frame of parameter request; and step S402: receiving a request instruction frame of parameter setting.

In one embodiment, in step S401, the node receives the instruction frame of parameter request from the main controller. In step S402, the node sends the request instruction frame of parameter response to the main controller. In step S303, the node validates the received parameters to determine whether to store the parameters or not. In step S304, conducting a configuration according to the parameters after validating, and sending the response instruction frame of parameter setting to the main controller to report the parameter configuration result. Wherein the parameters are encapsulated into M number of data frames, and the M number of data frames are sequentially received by the node, M is the positive integer equal to or greater than 1, and M is equal to or less than 128. The node further performs reporting the abnormal data transmission and the resending the data frames when receiving the N-th data frame. The process of reporting the abnormal data transmission and the resending the data frames is the same as the previous embodiment, and thus will be omitted hereinafter. Wherein N is the positive integer equal to or less than M, and N is equal to or greater than M/2, or N is equal to M.

In the embodiment, the parameter setting method for system bus can realize the transmission accuracy and the setting of the parameters for each node of the robot.

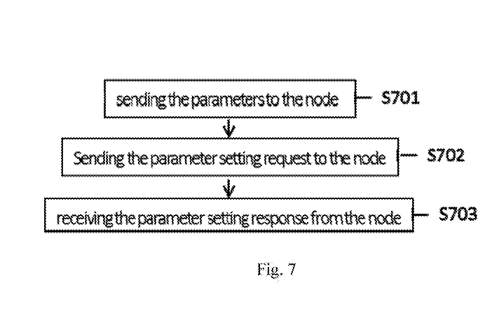

FIG. 7 is a flowchart illustrating a parameter setting method for system bus in accordance with another embodiment of the present disclosure.

In one embodiment, the parameter setting method for buses, includes step S701: sending the parameters to the node; step S702: sending the parameter setting request to the node, wherein the parameter setting request is configured to request the node to perform setting according to the parameters; step S703: receiving the parameter setting response from the node.

In one embodiment, after the step of sending the parameters to the node, the method further includes sending the parameter receiving request to the node; and receiving the parameter receiving response from the node.

In one embodiment, the parameters are encapsulated into M number of data frames, and the M number of data frames are sequentially sent to the node, wherein M is the positive integer equal to or greater than 1, and M is equal to or less than 128.

In one embodiment, the parameter setting method for system bus includes receiving the message reporting the abnormal data transmission, from the node; and, resending the data frames being transmitted abnormally upon receiving the message.

In one embodiment, the message of the abnormal data transmission includes the number of the abnormally transmitted data frames and the sequence number of the abnormally transmitted data frames during the data transmission.

In one embodiment, before the step of receiving the message of the abnormal data transmission, the method further including sending the N-th data frame to the node for one or more than one time, wherein N is a positive integer. Alternatively, the N-th data frame, is the last data frame in the data transmission; or N is equal to or greater than M/2.

In one embodiment, after the step of resending the data frames being transmitted abnormally, the method further including sending the N-th data frame to the node for one or more than one time.

In one embodiment, before the step of sending the N-th data frame to the node for one or more than one time, the method further includes sequentially sending the first to the (N−1)-th data frames. Wherein the abnormally transmitted data frames during the data transmission are a portion or all of the data frames from the first data frame to the (N−1)-th data frame.

In one embodiment, the parameter setting method for system bus includes receiving the parameters from the main controller; receiving the parameter setting request from the main controller; validating the parameters; conducting configuration according to the parameters after validating, and sending the parameter setting response to the main controller.

In one embodiment, before the step of receiving the parameters from the main controller, the method further includes receiving the parameter receiving request from the main controller; and sending the parameter receiving response to the main controller.

In one embodiment, the parameters are encapsulated by the main controller into M number of data frames, the M number of data frames are sequentially receiving by the node, wherein M is the positive integer equal to or greater than 1, and M is equal to or less than 128.

In one embodiment the parameter setting method for system bus further includes sending the message of the abnormal data transmission to the main controller when the number of the abnormally transmitted data frames in the data transmission reaches a threshold value or when receiving the N-th data frame more than one time, wherein N is the positive integer.

In one embodiment, the N-th data frame is the last data frame in the data transmission; or N is equal to or greater than M/2.

In one embodiment, after the step of sending the message of the abnormal data transmission, the method further includes re-receiving the data frames being transmitted abnormally.

In one embodiment, after the step of re-receiving the data frames being transmitted abnormally, the method further includes receiving the N-th data frame from the receiving node one or more than one time.

In one embodiment, the parameter receiving request and/or the parameter receiving response may include the node information, the parameter information, the frame-type indication information, the frame-type indication information.

In one embodiment, the parameter selling request the parameters are encapsulated into M number of data frames, and the M number of data frames are sent to the node, wherein M is a positive integer equal to or greater than 1, and M is equal to or less than 128.

In one embodiment, the parameter setting response the parameters are encapsulated into M number of data frames, and the M number of data frames are sent to the node, wherein M is a positive integer equal to or greater than 1, and M is equal to or less than 128.

The technical effect of the parameter setting method for buses in the embodiment is described above, and is not described in detail here.

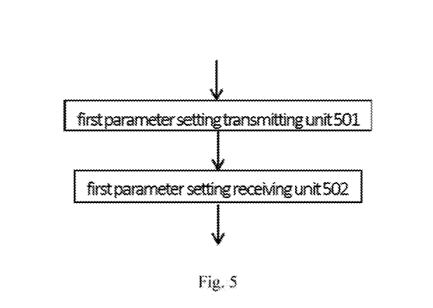

FIG. 5 is a schematic view of a parameter setting device for system bus of a robot in accordance with one embodiment of the present disclosure.

In the embodiment, the parameter setting device for system bus of the robot includes a first parameter setting transmitting unit 501 and a first parameter setting receiving unit 502.

The first parameter setting transmitting unit 501 is configured to send the parameters and the instruction frame of parameter setting to the node, wherein the instruction frame of parameter setting is configured to request the node to conduct configuration according to the parameters.

The first parameter setting receiving unit 502 is configured to receive the response instruction frame of parameter setting from the node.

The first parameter setting transmitting unit 501 is further configured to send the instruction frame of parameter request to the node before sending the parameters.

The first parameter setting receiving unit 502 is further configured to receive the instruction frame of parameter response from the node.

The controller for robots in the embodiment can realize the parameter transmission and setting for each node of the robots.

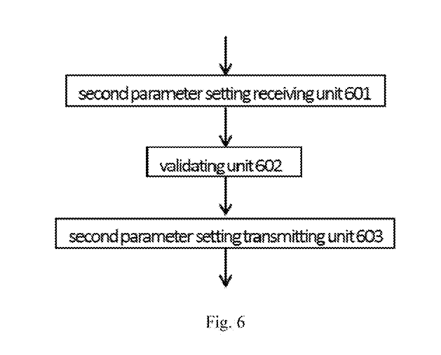

FIG. 6 is a schematic view of a parameter setting device for system bus of a robot in accordance with another embodiment of the present disclosure.

In the embodiment, the parameter setting device for system bus of the robot includes a second parameter setting receiving unit 601, a validating unit 602, and a second parameter setting transmitting unit 603.

The second parameter setting receiving unit 601 is configured to receive the parameters and the request instruction frame of parameter setting from the main controller.

The validating unit 602 is configured to validate the parameters and to conduct the corresponding configuration according to the parameters after validating.

The second parameter setting transmitting unit 603 is configured to send the response Instruction frame of parameter setting to the main controller.

The parameter setting device for system bus of the robot in the embodiment can realize the parameter transmission and setting for each node of the robots.

In one embodiment, the parameter setting device for system bus of the robots includes the first parameter setting transmitting unit configured to send the parameters and the parameter setting request to the node, the parameter setting request is configured to request the node to conduct configuration according to the parameters; and the first parameter setting receiving unit configured to receive the parameter setting response from the node.

In one embodiment, the first parameter setting transmitting unit is further configured to send the parameter receiving request to the node before sending the parameters; and the first parameter setting receiving unit receives the parameter receiving response.

In one embodiment, the parameters are encapsulated into M number of data frames, and the first parameter setting transmitting unit includes the first transmitting unit configured to sequentially sends the M number of data frames, wherein M is the positive integer equal to or greater than 1, and M is equal to or less than 128.

In one embodiment, the parameter setting device for system bus of the robot further includes a first receiving unit configured to receive the message reporting the abnormal data transmission, and a resending unit configured to resend the data frames being transmitted abnormally.

In one embodiment, the first receiving unit receives the message of the abnormal data transmission after the first transmitting unit sends the N-th data frame for one or more than one time, N is the positive integer.

In one embodiment, the N-th data frame is the last data frame in the data transmission; or N is equal to or greater than M/2, M is the total number of the data frames in the data transmission.

In one embodiment, the first transmitting unit sends the N-th data frame for one or more than one time after the resending unit resends the data frames being transmitted abnormally.

In one embodiment, the first transmitting unit sequentially sends the first to the (N−1)-th data frame for one time. The abnormally transmitted data frames in the data transmission are a portion or all of the number of the data frames from the first data frame to the (N−1)-th data frame.

In one embodiment, the parameter setting device for system bus of the robot includes a second parameter setting receiving unit configured to receive the parameters and the parameter setting request from the main controller; a validating unit configured to validate the parameters and conduct the corresponding configuration according to the parameters after validating; and a second parameter setting transmitting unit configured to send the parameter setting response to the main controller.

In one embodiment, the second parameter setting receiving unit is configured to receive the parameter receiving request from the main controller before receiving the parameters from the main controller. The second parameter setting transmitting unit is further configured to send the parameter receiving response to the main controller.

In one embodiment, the parameters are encapsulated, into M number of data frames. The second parameter setting receiving unit includes a second receiving unit configured to sequentially receive the M number of data frames, M is the positive integer equal to or greater than 1, and M is equal to or less than 128.

In one embodiment, the parameter setting device for system bus of the robot further includes a second transmitting unit configured to send the message of the abnormal data transmission; and a re-receiving unit configured to re-receive the data frames being transmitted abnormally.

In one embodiment, the second transmitting unit sends the message of the abnormal data transmission after the second receiving unit receives the N-th data frame one or more than one time, N is the positive integer.

In one embodiment, the N-th data frame is the last data frame in the data transmission; or N is equal, to or greater than M/2, M is the total number of the data frames in the data transmission.

In one embodiment, the second receiving unit receives the N-th data frame one or more than one time after the re-receiving unit re-receives the message of the abnormal data transmission.

In one embodiment the second receiving unit sequentially the first data frame to (N−1)-th data frames one time. The abnormally transmitted data frame during the data transmission are a portion or all of the total number of the data frames from the first data frame to the (N−1)-th data frame.

In one embodiment, the parameter setting device for system bus of the robot further includes a calculating unit configured to calculate the number of the abnormally transmitted data frames during the data transmission.

In one embodiment, the second transmitting unit sends the message of the abnormal data transmission when the number calculated by the calculating unit reaches the threshold value.

The technical effect of the parameter setting device for system bus of the robot in the embodiments is described as above, and not described in detail here.

In an example, the present disclosure further provides non-transitory computer readable medium, for example, memory including the instructions that can be executed by the processor to utilize the above method. The non-transitory computer readable medium may be a read only memory (ROM), a random access memory (RAM), magnetic tapes or optical data storage devices.

A person skilled in the art should understand that the disclosed combinations of various exemplary logical blocks, modules, circuits, and algorithm steps described in the present disclosure may be implemented as electronic hardware, computer software or a combination of both. In order to clearly describe such interchangeability of the hardware and software, functions of the various exemplary components, blocks, modules, circuits, and algorithm steps have been generally described thereof. Whether such functions are implemented as software or hardware depends on the specific application and the design restrictions applied to the entire system. A person skilled in the art may implement the above described functions in various manners in combination with the specific applications. However, such implementation decisions shall not be construed as causing a departure from the scope of the present disclosure.

While the foregoing disclosure illustrates exemplary embodiments of the present disclosure, it should be noted that without departing from the scope defined by the claims of the disclosed premise, various modifications and changes can be made. A method according to an embodiment of the disclosure described herein required functions, steps and/or actions need not be performed in any particular order. In addition, although elements of the present disclosure may be described or claimed in the individual form, but they can also be envisaged more unless explicitly restricted to the singular.

The above description is merely the embodiments in the present disclosure, the claim is not limited to the description thereby. The equivalent structure or changing of the process of the content of the description and the figures, or to implement to other technical field directly or indirectly should be included in the claim.

The CAN protocol relates to a point-to-multipoint and serial communication protocol for real-time applications. The CAN adopts twisted pair to transmit signals, which is one of the most widely used field buses in the world. The CAN protocol is robust, and thus may be widely used in the field of automation and other applications.

What is claimed is:

1. A parameter setting method for system bus of a robot, the method comprising:
sending, through a robot main controller, a parameter receiving request to a robot node;
receiving a parameter receiving response from the robot node;
sending parameters to the robot node;
sending a parameter setting request to the robot node; and
receiving a parameter setting response from the robot node;
wherein the parameters are encapsulated into M number of data frames, and the M number of data frames are sent to the node, wherein M is a positive integer equal to or greater than 1.

2. The method, as claimed in claim 1, wherein the method further comprises:
receiving a message reporting an abnormal data transmission from the robot node; and
resending data frames being transmitted abnormally upon receiving the message.

3. The method as claimed in claim 2, wherein the parameter receiving request comprises a node information, a parameter information, a frame-mode indication information or a frame-type indication information.

4. The method as claimed in claim 2,
wherein the step of receiving the message of the abnormal data transmission, from the robot node comprises receiving the message of the abnormal data transmission upon resending a duplicate data frame, and the message of the abnormal data transmission comprises the number of the abnormally transmitted data frames and the sequence number of the abnormally transmitted data frames during the data transmission;
wherein the step of resending data frames being transmitted abnormally upon receiving the message comprises resending the corresponding data frames according to the sequence number of the abnormally transmitted data frames.

5. The method as claimed in claim 1, wherein M is equal to or less than 128.

6. A parameter setting method for bus of a robot, the method comprising:
receiving a parameter receiving request from a robot main controller;
sending a parameter receiving response to the robot main controller,
receiving parameters from the robot main controller;
receiving a parameter setting request from the robot main controller;
validating the parameters; and
conducting configuration according to the parameters after validating the parameters, and sending a parameter setting response to the robot master controller;
wherein the parameters are encapsulated into M number of data frames, and the M number of data frames are sent to a robot node, wherein M is a positive integer equal to or greater than 1.

7. The method as claimed in claim 6, wherein the method further comprises:
sending a message reporting an abnormal data transmission to the robot main controller; and
re-receiving data frames being transmuted abnormally upon detecting an abnormal data transmission.

8. The method as claimed in claim 7, wherein the parameter receiving request comprises a node information, a parameter information, a frame-mode indication information or a frame-type indication information.

9. The method as claimed in claim 7, wherein the step of sending the message reporting the abnormal data transmission comprises sending the message of the abnormal data transmission upon receiving a duplicate data frame, and the message of the abnormal data transmission comprises the number of the abnormally transmitted data frames and the sequence number of the abnormally transmitted data frames during the data transmission.

10. The method as claimed in claim 6, wherein M is equal to or less than 128.

11. A parameter setting device for bus of a robot, comprising:
one or more processors; and
a memory; and
one or more programs;
wherein the one or more programs are stored in the memory and configured to be executed by the one or more processors, the one or more programs comprise: instructions for sending a parameter receiving request to a robot node; instructions for receiving a parameter receiving response from the robot node; instruction for sending parameters to the robot node; instructions for sending a parameter setting request to the robot node; and instructions for receiving a parameter setting response from the robot node;
wherein the parameters are encapsulated into M number of data frames, and the M number of data frames are sent to the node, wherein M is a positive integer equal to or greater than 1.

12. The device as claimed in claim 11, wherein the one or more programs further comprise; instructions for receiving a message reporting an abnormal data transmission from the node; and instructions for resending data frames being transmitted abnormally upon receiving the message.

13. The device as claimed in claim 12, wherein the parameter receiving request comprises a node information, a parameter information, a frame-mode indication information or a frame-type indication information.

14. The device as claimed in claim 13, wherein the instructions for receiving the message of the abnormal data transmission from the node is upon resending a duplicate data frame, and the message of the abnormal data transmission comprises the number of the abnormally transmitted data frames and the sequence number of the abnormally transmitted data frames during the data transmission; and
the one or more programs further comprise; instructions for resending the corresponding data frames according to the sequence number of the abnormally transmitted data frames.

15. The device as claimed in claim 11, wherein M is equal to or less than 128.
